(19) United States
(12) Patent Application Publication
(10) Pub. No.: US 2017/0345027 A1
(43) Pub. Date: Nov. 30, 2017

(54) SALES DATA PROCESSING APPARATUS AND METHOD FOR ACQUIRING ATTRIBUTE INFORMATION OF CUSTOMER

(71) Applicant: TOSHIBA TEC KABUSHIKI KAISHA, Tokyo (JP)

(72) Inventor: Takahiro Saitou, Izunokuni (JP)

(21) Appl. No.: 15/168,311

(22) Filed: May 31, 2016

(51) Int. Cl. G06Q 30/02; G06K 9/00

(52) U.S. Cl. CPC G06Q 30/0201; G06K 9/00288; G06K 9/00255; G06K 9/00268

(57) ABSTRACT

A sales data processing apparatus comprises a display section configured to display information by switching a view angle from a wide angle to a narrow angle or vice versa, a customer guidance module configured to guide a face of a customer to a position confronting a camera by switching the view angle of the display section from the wide angle to the narrow angle when transaction information of a sales object to which a transaction processing is carried out is displayed on the display section, an attribute determination module configured to determine attributes corresponding to face information obtained by photographing the face of the customer who is guided to the position by the customer guidance module and an association module configured to associate attribute information of the attributes determined by the attribute determination module with sales object information of the sales object to which the transaction processing is carried out.

### CROSS-REFERENCE TO RELATED APPLICATION

This application is based upon and claims the benefit of priority from Japanese Patent Application No. 2015-066561, filed Mar. 27, 2015, the entire contents of which are incorporated herein by reference.

### FIELD

Embodiments described herein relate to a sales data processing apparatus and a method for acquiring attribute information of a customer.

### BACKGROUND

A retail store such as a convenience store collects attribute information such as a gender and an age bracket of a customer for a clientele analysis of customers who purchase commodities and a sales analysis of the commodities. Recently, according to an image of a customer captured by a camera arranged in a POS terminal (Point of Sales) or in the store, the POS terminal determines the attribute information of the customer.

Incidentally, it is necessary to photograph a face of the customer at his or her front side to input his or her attribute information according to the image of the customer. However, in a case in which the customer does not face the camera in a conforming manner, there is a possibility that the attribute information of the customer cannot be acquired, because the face of the customer is not correctly detected.

### DESCRIPTION OF THE DRAWINGS

FIG. 1 is a schematic plan view illustrating a state, viewed from the upper side, in which a POS terminal according to an embodiment is arranged in a store;

FIG. 2 is a perspective view illustrating the appearance of the POS terminal according to the embodiment at an operator side;

FIG. 3 is a perspective view illustrating the appearance of the POS terminal according to the embodiment at a customer side;

FIG. 4 is a plane view illustrating part of an operation section of the POS terminal;

FIG. 5 is a schematic diagram illustrating a principle of switching a view angle of a display section for customer;

FIG. 6 is a block diagram illustrating the hardware structure of the POS terminal;

FIG. 7 is a memory map illustrating an example of a face master file in the POS terminal;

FIG. 8 is a functional block diagram illustrating the functional components of the POS terminal; and

FIG. 9 is a flowchart illustrating the flow of a control processing carried out by the POS terminal.

### DETAILED DESCRIPTION

In accordance with an embodiment, a sales data processing apparatus comprises a display section configured to display information by switching a view angle from a wide angle to a narrow angle or vice versa, a customer guidance module configured to guide a face of a customer to a position confronting a camera by switching the view angle of the display section from the wide angle to the narrow angle when transaction information of a sales object to which a transaction processing is carried out is displayed on the display section, an attribute determination module configured to determine attributes corresponding to face information obtained by photographing the face of the customer who is guided to the position by the customer guidance module and an association module configured to associate attribute information of the attributes determined by the attribute determination module with sales object information of the sales object to which the transaction processing is carried out.

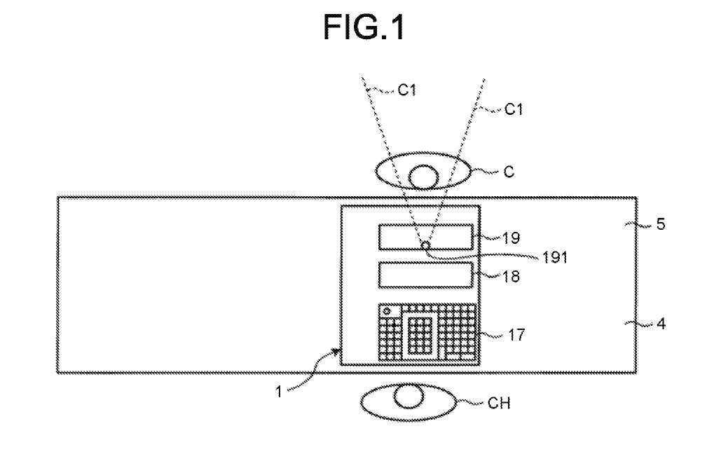

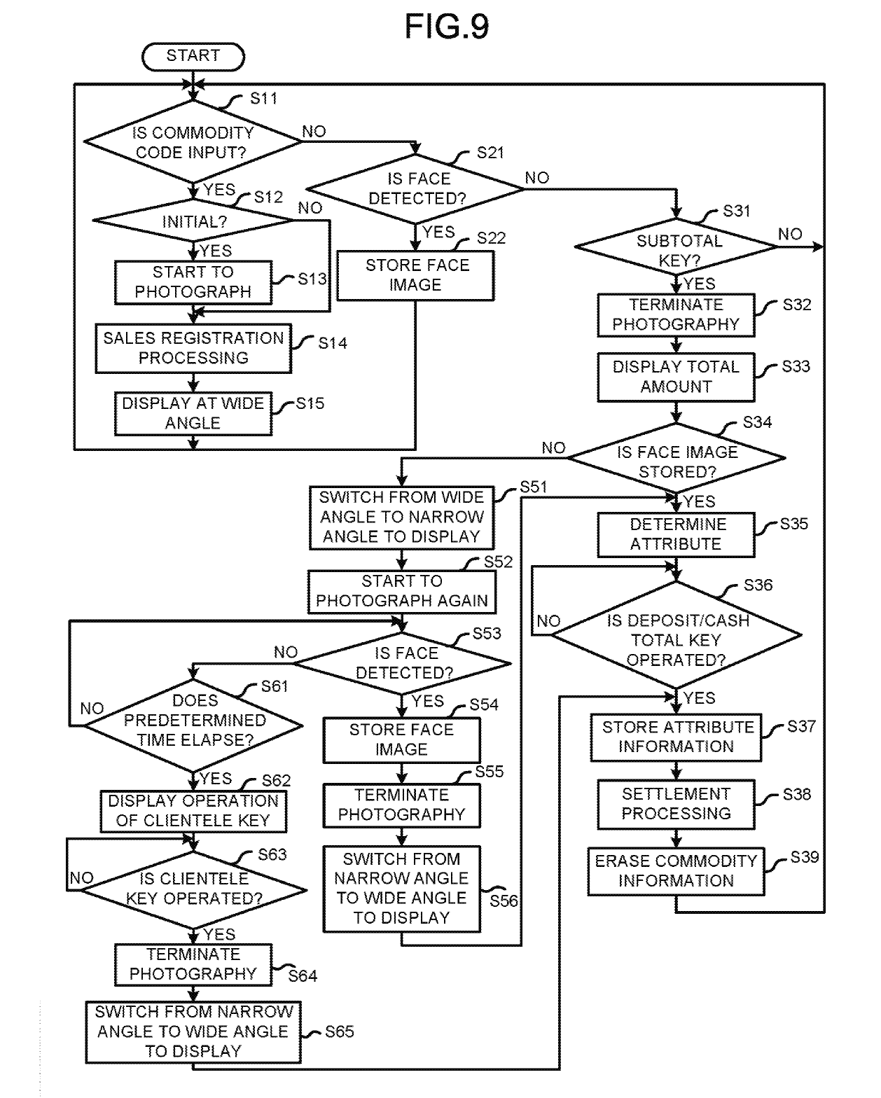

Hereinafter, the sales data processing apparatus according to the embodiment is described in detail with reference to FIG. 1˜FIG. 9. In the embodiment, a POS (Point of Sales) terminal is described as the sales data processing apparatus. Further, in the embodiment, a commodity is described as a sales object. The present invention is not limited by the embodiment described hereinafter.

FIG. 1 is a schematic plan view illustrating a state in which a POS terminal according to the embodiment is arranged in a store. A settlement place where commodities displayed in the store are sold is arranged in the store. FIG. 1 shows one of a plurality of lengthwise counters 4 in the settlement place. A flat plane 5 is formed on the upper surface of the counter 4, and a POS terminal 1 is arranged on the plane 5.

The POS terminal 1 carries out a sales registration relating to sales of commodities sold in the store. A store clerk acting as an operator CH operates the POS terminal 1 to execute a sales registration processing and a settlement processing of the sold commodities. The sales registration processing refers to a processing of optically reading a code symbol such as a barcode attached to the commodity to input the commodity code, displaying a commodity name and a price (commodity information) of the commodity read according to the input commodity code, and meanwhile storing the commodity information in a buffer. The settlement processing includes a processing of displaying a total amount relating to the transaction and change calculated based on the deposited amount paid by the customer according to the commodity information stored in the buffer through the sales registration processing, a processing of instructing a change machine to discharge the change and a processing of issuing a receipt on which the commodity information and settlement information (total amount, deposited amount, change amount, etc.) are printed. A processing of combining the sales registration processing with the settlement processing is referred to as a transaction processing.

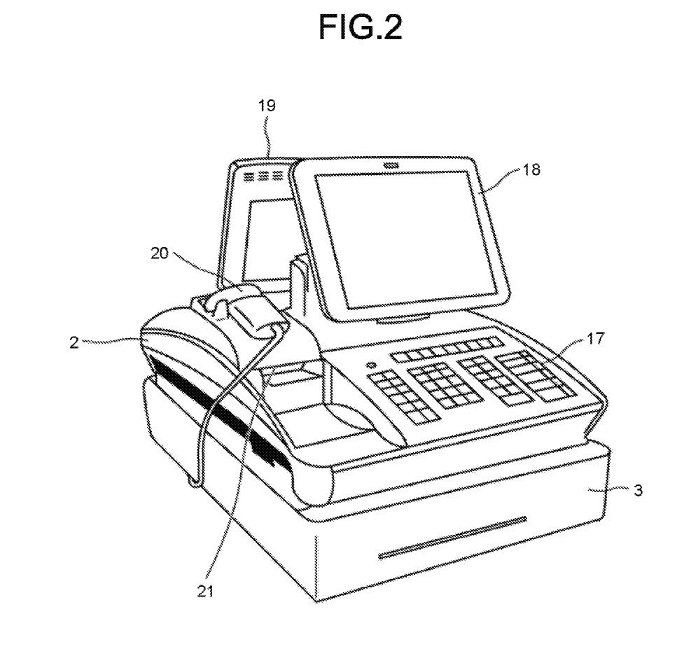

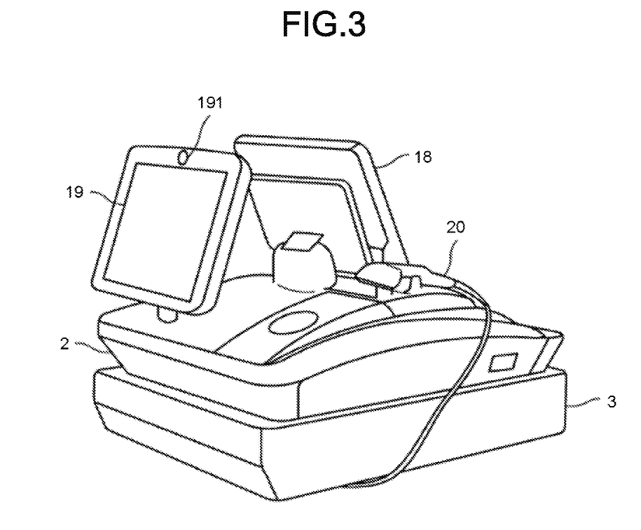

The POS terminal 1, which is described in detail with reference to FIG. 2 and FIG. 3, is provided with an operation section 17 such as a keyboard operated by the operator CH, a display section for operator 18 that displays information to the operator CH and a display section for customer 19 that displays information to a customer C. The operator CH operates the POS terminal 1 at the operator side of the counter 4. The customer C stands at the customer C side of the counter 4.

A camera 191 is arranged on the upper portion of the outer frame of the display section for customer 19. The camera 191 is constituted with a CCD (Charge Coupled Device) image sensor and the like. The camera 191 is arranged towards the customer C side and at a position where the customer C who stands in an area surrounded by chain lines C1 at the customer C side of the POS terminal 1 can view a screen on the display section for customer 19.

The camera 191 captures a moving image or continuous still images (collectively referred to as “image”) of the customer C who is performing a transaction. In the embodiment, for example, the camera 191 captures 10 images of the customer C per second. The images of the customer C captured by the camera 191 further includes clothes the customer C wears, in addition to the face.

FIG. 2 is a perspective view illustrating the appearance of the POS terminal 1 of the embodiment viewed at the operator CH side. In FIG. 2, the POS terminal 1 includes a main body 2 and a cash box 3. The cash box 3 equipped with a drawer stores cash such as bills and coins and securities such as a gift voucher received from the customer C, and change to be handed over to the customer C.

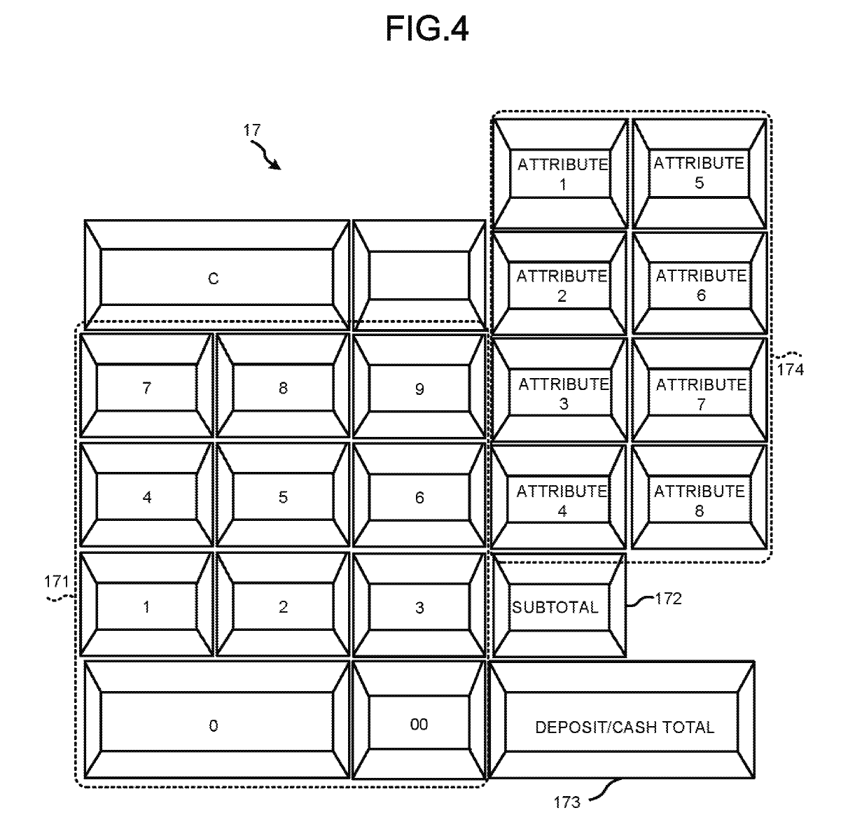

The main body 2 includes the operation section 17, the display section for operator 18, the display section for customer 19 and a reading section 20. The operation section 17 is a keyboard on which various keys such as numerical keys for inputting numerals, a subtotal key for declaring the end of a sales registration and a deposit/cash total key for declaring the end of a transaction (all the keys refer to FIG. 4) are arranged. The display section for operator 18 constituted by a liquid crystal display device displays information to the operator. The display section for customer 19 constituted by a liquid crystal display device displays information to the customer C.

The reading section 20 equipped with a CCD line sensor reads a code symbol such as a barcode or a two-dimensional code attached to a commodity and inputs the commodity code for specifying the commodity. In the embodiment, the reading section 20 of a handy type is used, and the operator CH closes or contacts the reading section 20 held with hand to or with the code symbol attached to the commodity to read the code symbol. The reading section 20 may be a scanner which emits light to scan the code symbol with a polygon-mirror and receives the light reflected from the code symbol.

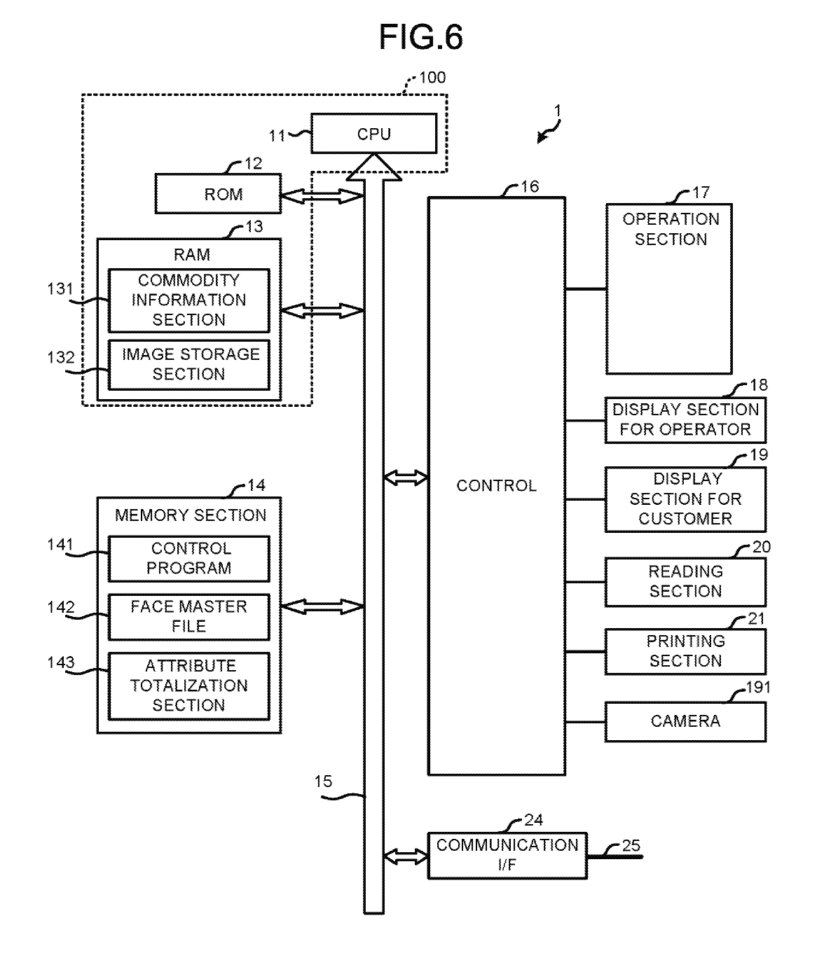

Further, the main body 2 includes a control section (refer to FIG. 6) of the POS terminal 1 and a printing section 21 therein. The printing section 21 takes out a rolled receipt paper housed in the main body 2, prints the commodity information and the settlement information on the receipt paper with a thermal printer having a thermal-transfer print head to issue the printed receipt paper as a receipt.

FIG. 3 is a perspective view illustrating the appearance of the POS terminal 1 viewed at the customer C side. In FIG. 3, the POS terminal 1 includes the camera 191 constituted by the CCD image sensor on the upper portion of an outer frame of the display surface of the display section for customer 19.

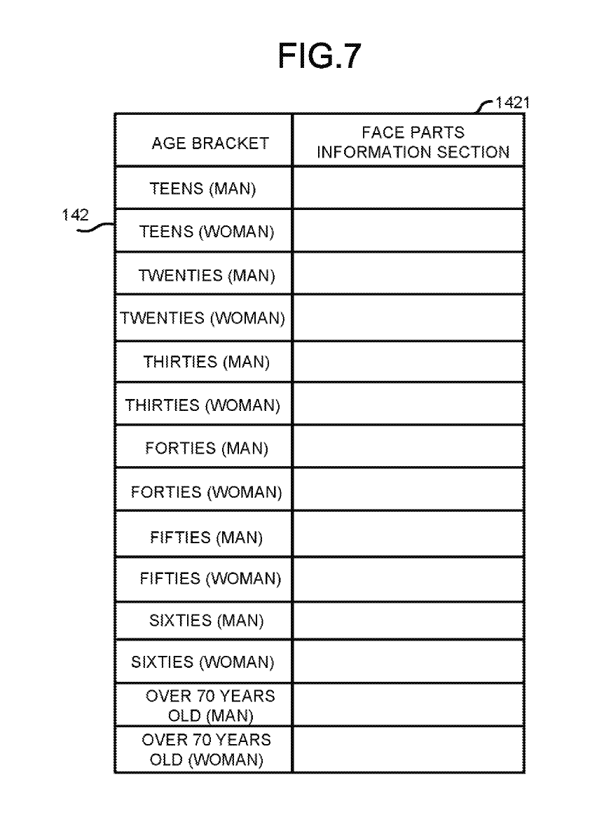

FIG. 4 is a plane view illustrating part of the operation section 17 of the POS terminal 1. As shown in FIG. 4, the operation section 17 is equipped with numerical keys 171, a subtotal key 172, a deposit/cash total key 173 and clientele keys 174 serving as attribute keys. The numerical keys 171 set numerals “0” ˜“9” to input, for example, the number of commodities. The subtotal key 172 is used to declare the end of the sales registration of commodities and the start of the settlement processing. The deposit/cash total key 173 is used to declare the end of the transaction with a customer. The clientele keys 174 are used to input attributes (gender and age bracket) of a customer. In the present embodiment, the operation section 17 displays 8 (eight) clientele keys 174 for convenience; however, the operation section 17 is actually equipped with 14 (fourteen) clientele keys corresponding to the number of clienteles shown in FIG. 7. The clientele keys 174 respectively correspond to different attributes, and each attribute corresponding to each operated clientele key 174 is output. For example, if an attribute 1 of the clientele key 174 is operated, the attribute information indicating an age bracket (10s) and a gender (male) is output.

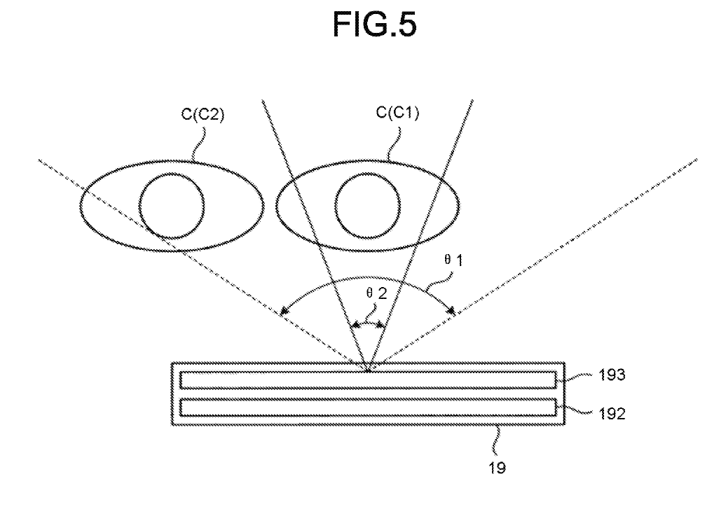

Next, a principle of switching a view angle of the display section for customer 19 is described with reference to FIG. 5. In FIG. 5, the display section for customer 19 has a structure including a main panel 192 and a switch panel 193 arranged on the main panel 192. The main panel 192 is a liquid crystal panel that displays characters and figures at a wide angle by applying a voltage thereto. The switch panel 193 is applied with a predetermined voltage to control orientation of liquid crystal molecules so that light from the main panel 192 is transmitted through the switch panel 193 in the front direction but not in the peripheral direction.

Thus, in a state in which no voltage is applied to the switch panel 193, the switch panel 193 enables light to be transmitted in all directions, and thus a view angle of the main panel 192 is a wide angle. That is, the view angle of the display section for customer 19 is wide, and therefore the display of the display section for customer 19 can be viewed clearly even from the peripheral direction. On the other hand, if the predetermined voltage is applied to the switch panel 193, the switch panel 193 enables light to be transmitted in the front direction but not in the peripheral direction, and thus the view angle of the main panel 192 becomes a narrow angle only in the front direction. That is, the view angle of the display section for customer 19 is narrow, and therefore the display of the display section for customer 19 can be viewed clearly from the front direction, but cannot be viewed clearly from the peripheral direction.

In FIG. 5, in a state in which no voltage is applied to the switch panel 193, the display section for customer 19 displays information with a view angle θ1 (wide angle). In this case, the customer C who stands within the range of the view angle θ1 can view the information displayed on the display section for customer 19. As shown in FIG. 5, a customer C1 who stands facing the display section for customer 19 and a customer C2 who stands at the peripheral position of the display section for customer 19 can clearly view the display on the display section for customer 19. On the other hand, in a state in which the predetermined voltage is applied to the switch panel 193, the display section for customer 19 displays information with a view angle θ2 (narrow angle). In this case, the customer C1 who stands inside the view angle θ2 (a position facing the camera 191) with respect to the display section for customer 19 can clearly view the display of the display section for customer 19; however, the customer C2 who stands at the peripheral position outside the view angle θ2 with respect to display section for customer 19 cannot clearly view the display of the display section for customer 19.

Next, hardware of the POS terminal 1 is described with reference to FIG. 6 and FIG. 7. FIG. 6 is a block diagram illustrating the hardware structure of the POS terminal 1. In FIG. 6, the POS terminal 1 includes a CPU (Central Processing Unit) 11, a ROM (Read Only Memory) 12, a RAM (Random Access Memory) 13 and a memory section 14. The CPU 11 is a main body for control. The ROM 12 stores various programs. The RAM 13 copies or decompresses programs and various data. The memory section 14 stores various programs. The CPU 11, the ROM 12, the RAM 13 and the memory section 14 are connected with each other via a data bus line 15. The CPU 11, the ROM 12 and the RAM 13 constitute a control section 100. The control section 100 carries out a control processing described later through the operation of the CPU 11 according to a control program 141, stored in the ROM 12 and the memory section 14, which is copied or decompressed on the RAM 13.

The control section 100 enables the display section for customer 19 to be displayed at the wide angle without applying voltage to the switch panel 193. On the contrary, the control section 100 applies the predetermined voltage to the switch panel 193 to enable the display section for customer 19 to be displayed at the narrow angle. The control section 100 executes a control in which the view angle of the display section for customer 19 is switched from the wide angle to the narrow angle by applying the predetermined voltage to the switch panel 193 of the display section for customer 19 which is displayed at the wide angle. On the contrary, the control section 100 executes a control in which the view angle of the display section for customer 19 is switched from the narrow angle to the wide angle by stopping the voltage to the switch panel 193 of the display section for customer 19 which is displayed at the narrow angle.

The RAM 13 includes a commodity information section 131 and an image storage section 132. The commodity information section 131 stores commodity information (commodity name, price of a commodity, etc.) to which the sales registration processing is carried out in association with the commodity code read by the reading section 20. The image storage section 132 stores a face image of a customer C whose face is detected from an image captured by the camera 191. A face detection technology for detecting a face is a well-known technology in which all the parts (eyes, nose, mouth, ears, chin, etc.) of a face described later from an image captured by the camera 191 to detect the face of a person.

The memory section 14 is constituted by a non-volatile memory such as an HDD (Hard Disc Drive) and a flash memory in which storage information is held even if power is switched off to store programs including the control program 141. The memory section 14 includes a face master file 142 (refer to FIG. 7) and an attribute totalization section 143.

The attribute totalization section 143 totalizes commodity information of commodities (commodities purchased by a customer) to which the sales registration processing is carried out by the POS terminal 1 by attributes (gender and age bracket) in correspondence with attribute information of the customer who purchases the commodities to store it. A tendency or trend of purchasing a commodity by attributes can be analyzed according to the commodity information stored in the attribute totalization section 143.

Further, the operation section 17, the display section for operator 18, the display section for customer 19, the reading section 20, the printing section 21 and the camera 191 are connected via a controller 16 by the data bus line 15. The controller 16 receives an instruction from the control section 100 to control the operation section 17, the display section for operator 18, the display section for customer 19, the reading section 20, the printing section 21 and the camera 191. However, for the convenience of description, the control processing carried out by the controller 16 is described as being carried out by the control section 100.

The data bus line 15 is further connected with a communication I/F (Interface) 24. The communication I/F 24 is electrically connected with another POS terminal 1 arranged in the store and a store server (not shown) via a communication circuit 25. The store server is electrically connected with all the POS terminals 1 arranged in the store to collect commodity information and settlement information from each POS terminal 1. The store server sends the commodity information and the settlement information collected from each POS terminal 1 to a headquarters server (not shown) arranged in a headquarters.

FIG. 7 a memory map illustrating the face master file 142 included in the memory section 14. In FIG. 7, the face master file 142 includes a face parts information section 1421 that stores face parts information serving as face information in correspondence with each gender and each age bracket from 10s to over 70s. Each face parts information section 1421 stores face parts information for specifying individual attributes (age bracket and gender). The face master file 142 may be arranged in, for example, a store server (not shown) other than the POS terminal 1.

The face parts information refers to data, obtained by classifying a face of a person in accordance with parts and features, which indicates each part and feature of each attribute. For example, the data indicates features of parts containing eyes, nose, mouth, ears and chin and modified features of a face containing a smiling face, a straight face and the closing eyes and opening eyes. The face parts information stored by each attribute represents the feature of this attribute different from other attributes. For example, in the face parts information section 1421 of 10s (male), information of eyes, nose, mouth and ears indicating the features of a male of 10s and information of the smiling face and the straight face indicating the features of the male of 10s are stored. The face parts information corresponding to each attribute represents the each attribute remarkably, which is created according to a large amount of statistic data.

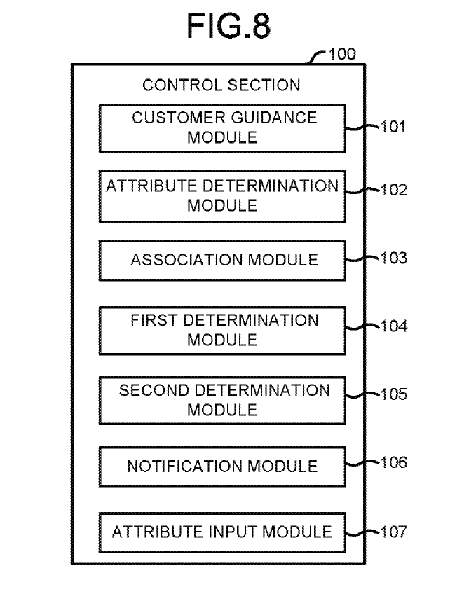

Subsequently, the control processing of the POS terminal 1 is described with reference to FIG. 8 and FIG. 9. FIG. 8 is a functional block diagram illustrating the functional components of the POS terminal 1. The control section 100 functions as a customer guidance module 101, an attribute determination module 102, an association module 103, a first determination module 104, a second determination module 105, a notification module 106 and an attribute input module 107 according to various programs containing the control program 141 stored in the ROM 12 and the memory section 14.

The customer guidance module 101 has a function of guiding the face of a customer to the position confronting the camera 191 by switching the view angle of the display section for customer 19 from the wide angle to the narrow angle when the information of the sales object to which the transaction processing is carried out is displayed on the display section for customer 19.

The attribute determination module 102 has a function of determining attributes corresponding to face information which is obtained by photographing a face guided to the position by the customer guidance module 101.

The association module 103 has a function of associating attribute information of the attributes determined by the attribute determination module 102 with the commodity information of commodities to which the transaction processing is carried out.

The first determination module 104 has a function of determining whether or not a face of a customer C is detected from the face image captured by the camera 191.

The second determination module 105 has a function of determining whether or not the face of the customer C guided to the position by the customer guidance module 101 is detected from the face image captured by the camera 191 if it is determined by the first determination module 104 that the face of the customer C is not detected.

The notification module 106 has a function of notifying an operator of a message to instruct the input of attribute information of a customer through an operation by the operator if it is determined by the second determination module 105 that the face of the customer C is not detected.

The attribute input module 107 has a function of inputting the attribute information indicating attributes of the customer through the operation by the operator.

FIG. 9 is a flowchart illustrating the flow of the control processing carried out by the POS terminal 1. In FIG. 9, the control section 100 determines whether or not a commodity code is input after the reading section 20 reads the commodity code attached to a commodity (ACT S11). If it is determined that the commodity code is read (Yes in ACT S11), the control section 100 determines whether or not the commodity code input in ACT S11 is the commodity code of the first commodity in the transaction (ACT S12). The control section 100 determines that the commodity code input in ACT S11 is the initial input commodity code in the transaction if no commodity information of a commodity is stored in the commodity information section 131.

If it is determined that the commodity code input in ACT S11 is the initial input commodity code in the transaction (Yes in ACT S12), the control section 100 activates the camera 191 to start to photograph the customer C with the camera 191 (ACT S13). Then, the control section 100 executes the sales registration processing on the basis of the input commodity code and then stores the commodity information in the commodity information section 131 (ACT S14). Next, the control section 100 (Wide display module) displays the commodity information stored in the commodity information section 131 on both the display section for operator 18 and the display section for customer 19 at the wide angle (ACT S15). Then, the control section 100 returns to the processing in ACT S11.

On the other hand, if it is determined that no commodity code is input (No in ACT S11), the control section 100 determines whether or not a face is detected from the image captured by the camera 191 with the use of the foregoing face detection technology (ACT S21). If it is determined that the face is detected (Yes in ACT S21), the control section 100 stores the face image of the detected face in the image storage section 132 (ACT S22). Then, the control section 100 returns to the processing in ACT S11.

Further, if it is determined that the face is not detected from the image captured by the camera 191 (No in ACT S21), the control section 100 determines whether or not the subtotal key 172 is operated (ACT S31). If it is determined that the subtotal key 172 is operated (Yes in ACT S31), the control section 100 terminates the photography of the customer C by the camera 191 (S32). Then, the control section 100 displays commodity information of each commodity and total amount in the transaction according to the commodity information stored in the commodity information section 131 (ACT S33). In ACT S33, it may be applicable that the commodity information is not necessarily displayed but only the total amount is displayed.

Next, the control section 100 (first determination module 104) determines whether or not the face image of the customer C whose face is detected is stored in the image storage section 132 (ACT S34). If it is determined that the face image is stored (Yes in ACT S34), the control section 100 (attribute determination module 102) determines the attributes of the customer C according to the stored face image (ACT S35). The control section 100 collates the face parts information contained in the face image of the customer C stored in the image storage section 132 with each face parts information stored in the face parts information section 1421. Then, the control section 100 extracts the attribute information of the attributes corresponding to the face parts information contained in the face image that is coincident with the face parts information stored in the face parts information section 1421 to determine the attributes extracted, as attributes of the customer C.

Next, the control section 100 determines whether or not the deposit/cash total key 173 is operated by the operator CH (ACT S36). The control section 100 waits for until the deposit/cash total key 173 is operated (No in ACT S36), but contrarily, if it is determined that the deposit/cash total key 173 is operated (Yes in ACT S36), the control section 100 executes processing in ACT S37˜ACT S39 to the end of the transaction.

The control section 100 (association module 103) stores the commodity information stored in the commodity information section 131 and the attribute information indicating the attributes determined in ACT S35 in the attribute totalization section 143 in an associated manner (ACT S37). The stored attribute information is accumulated and is used in the clientele analysis and the sales analysis of the commodities. Next, the control section 100 executes the settlement processing according to the commodity information stored in the commodity information section 131 (ACT S38). After the settlement processing is terminated, the control section 100 erases the commodity information stored in the commodity information section 131 (ACT S39). Then, the control section 100 returns to the processing in ACT S11.

On the other hand, if it is determined that the face image of the customer C whose face is detected is not stored in the image storage section 132 (No in ACT S34), the control section 100 (customer guidance module 101) applies voltage to the switch panel 193 of the display section for customer 19 to switch the view angle of the display section for customer 19 from the wide angle to the narrow angle to display the commodity information and the total amount (ACT S51). At this time, the commodity information and the total amount of each commodity formerly displayed at the wide angle are displayed at the narrow angle. In this case, after the control section 100 switches the view angle of the display section for customer 19 which displays the commodity information and the total amount from the wide angle to the narrow angle, the customer C (face of the customer C) who stands outside the narrow view angle θ2 is guided to the position (position at the inner side of the narrow view angle θ2) confronting the camera 191 at which the camera 191 can photograph the face of the customer C at the front side in order that the customer C can clearly view the display of the display section for customer 19. The position confronting the camera 191 is the optimum position right in front of the camera 191; however the position is set free as long as it is at the inner side of the narrow view angle θ2 but not necessarily right in front.

After that, the control section 100 displays transaction information at the narrow view angle θ2. The control section 100 activates the camera 191 again to start to photograph the customer C with the camera 191 (ACT S52). Then, the control section 100 (second determination module 105) determines whether or not the face is detected from the image captured by the camera 191 with the use of the foregoing face detection technology (ACT S53).

In ACT S51, since the view angle of the display section for customer 19 is narrow to θ2, the customer C2 (face of the customer C) is guided to the position confronting the camera 191 to view the display of the display section for customer 19 more clearly. Thus, the camera 191 can capture the image of the face of the customer C at nearly the front side. Therefore, the face of the customer C is detected easily from the image captured by the camera 191.

If it is determined that the face is detected (Yes in ACT S53), the control section 100 stores the face image of the detected face in the image storage section 132 (ACT S54). Then, the control section 100 terminates the photographing of the customer C by the camera 191 (ACT S55). Next, the control section 100 stops the application of the voltage to the switch panel 193 to switch the view angle of the display section for customer 19 to the wide angle (ACT S56). After that, the control section 100 displays transaction information at the wide angle. Then the control section 100 executes the processing in and after ACT S35.

Further, if it is determined that the face is not detected from the image captured by the camera 191 (No in ACT S53), the control section 100 determines whether or not a predetermined time elapses in a state in which the face is not being detected (ACT S61). If it is determined that the predetermined time does not elapse (No in ACT S61), the control section 100 returns to the processing in ACT S53. On the other hand, if it is determined that the predetermined time elapses (Yes in ACT S61), the control section 100 (notification module 106) displays a message indicating the operation of the clientele keys 174 on the display section for operator 18 to instruct the operator CH to input the attribute information (ACT S62).

The message is displayed for the operator CH if the POS terminal 1 cannot determine attributes of a customer who performs transaction now. The message is used to instruct the operator CH to determine attributes of the customer C and operate the appropriate clientele key 174 to input attribute information. The operator CH who sees the display of the message determines the attributes of the customer C and operates one of the clientele keys 174 that appears to be appropriate to the attributes of the customer C. Thus, clientele information corresponding to the operated clientele key 174 is input.

The control section 100 (attribute input module 107) determines whether or not one of the clientele keys 174 is operated (ACT S63). The control section 100 waits for until one of the clientele keys is operated (No in ACT S63), but contrarily, if it is determined that one of the clientele keys is operated (Yes in ACT S63), the control section 100 terminates the photographing of the customer C by the camera 191 (ACT S64). Then, the control section 100 stops the application of the voltage to the switch panel 193 to switch the view angle of the display section for customer 19 to the wide angle (ACT S65). As the operation of the clientele keys 174 also indicates the declaration of the end of the transaction, afterwards, the control section 100 executes processing in ACT S37˜ACT S39 relating to the end of the transaction. In ACT S37, the control section 100 stores the attribute information indicating the attributes input in ACT S63 and the commodity information (sales object information) stored in the commodity information section 131 in the attribute totalization section 143 in an associated manner. Further, in ACT S31, if it is determined that the subtotal key 172 is not operated (No in ACT S31), the control section 100 returns to the processing in ACT S11.

According to the foregoing embodiment, the control section 100 displays the transaction information on the display section for customer 19 at the wide angle and then determines whether or not the face of the customer C who sees the transaction information is detected. Then, if the face of the customer C is not detected, the control section 100 switches the view angle of the display section for customer 19 from the present angle to the narrow angle while the transaction information is displayed. The customer C (face of the customer C) is guided to the position confronting the camera 191 arranged on the display section for customer 19 to see the display of the display section for customer 19 of which the view angle is narrowed, and thus the camera 191 can photograph the face of the customer at the front side. The control section 100 can detect the face of the customer C with a higher probability. In other words, such a POS terminal 1 can detect the face of the customer with a higher probability, and thus can reduce probability of failing the detection of the face. The control section 100 determines the attributes of the customer C according to the face information of the detected face.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment, at a timing at which the commodity information and the total amount are displayed by operating the subtotal key 172, the control section 100 determines whether or not the face image is stored and then switches the view angle of the display section for customer 19 from the wide angle to the narrow angle. However, it is not limited to this. For example, at a timing at which the control section 100 activates the camera 191 to start the photographing of the customer C (ACT S13), the control section 100 may switch the view angle of the display section for customer 19 from the wide angle to the narrow angle. In this case, since the customer C (face of the customer C) is guided to the position confronting the camera 191 at the early stage, the probability of detecting the face in ACT S21 is increased. The timing at which the control section 100 activates the camera 191 to start the photographing of the customer C is optional. Further, the timing at which the control section 100 activates the camera 191 to start the photographing of the customer C may be optionally set.

In the embodiment, the commodity information and the total amount information are described as an example of the information of the sales object to which the transaction processing is carried out; however, the present invention is not limited to this. The information of the sales object to which the transaction processing is carried out may contain information of amount deposited by the customer C and information of change amount handed over to the customer C.

Further, for example, in the embodiment, the camera 191 captures the continuous still images, but may also capture the moving images.

Further, in the embodiment, the commodity is described as an example of the sales object; however, the sales object (e.g. service) other than the commodity may be exemplified.

Programs executed by the sales data processing apparatus of the embodiment may be recorded in a computer-readable recording medium such as CD-ROM, FD (Flash Disk), CD-R and DVD (Digital Versatile Disc) in the form of installable or executable file to be provided.

The programs executed by the sales data processing apparatus of the embodiment may be stored in a computer connected with a network such as an Internet and downloaded via the network to be provided. Further, the programs executed by the sales data processing apparatus of the embodiment may be provided or distributed via the network such as the Internet.

The programs executed by the sales data processing apparatus of the embodiment may be incorporated into the ROM in advance.

What is claimed is:

1. A sales data processing apparatus, comprising:
a display section configured to display information by switching a view angle from a wide angle to a narrow angle or vice versa;
a customer guidance module configured to guide a face of a customer to a position confronting a camera by switching the view angle of the display section from the wide angle to the narrow angle when transaction information of a sales object to which a transaction processing is carried out is displayed on the display section;
an attribute determination module configured to determine attributes corresponding to face information obtained by photographing the face of the customer who is guided to the position by the customer guidance module; and
an association module configured to associate attribute information of the attributes determined by the attribute determination module with sales object information of the sales object to which the transaction processing is carried out.

2. The sales data processing apparatus according to claim 1, further comprising
a first determination module configured to determine whether or not the face of the customer is detected from the face photographed by the camera, wherein
the attribute determination module determines attributes corresponding to the face information on the basis of the face information of the detected face if the first determination module determines that the face of the customer is detected; and
the customer guidance module displays the transaction information by switching the view angle of the display section to the narrow angle if the first determination module determines that the face of the customer is not detected.

3. The sales data processing apparatus according to claim 2, further comprising
a second determination module configured to determine whether or not the face of the customer guided by the customer guidance module is detected from a face image captured by the camera if the first determination module determines that the face of the customer is not detected, wherein
the attribute determination module determines the attributes corresponding to the face information on the basis of the face information of the detected face if the second determination module determines that the face is detected.

4. The sales data processing apparatus according to claim 3, further comprising
a notification module configured to notify an operator of a message to instruct the input of the attribute information of the customer through an operation of the operator if the second determination module determines that the face is not detected; and
an attribute input module configured to input the attribute information indicating the attributes of the customer through the operation of the operator.

5. The sales data processing apparatus according to claim 1, further comprising
an end key configured to declare the end of the transaction with the customer, wherein
the association module associates the attribute information of the attributes determined by the attribute determination module with the sales object information of the sales object to which the transaction processing is executed if the end key is operated after the attribute determination module determines the attributes of the customer.

6. A method for acquiring attribute information of a customer by a sales data processing apparatus having a display section which displays information by switching a view angle from a wide angle to a narrow angle or vice versa, including:
guiding the face of the customer to a position confronting a camera by switching the view angle of the display section from the wide angle to the narrow angle when information of a sales object to which a transaction processing is carried out is displayed on the display section;
determining attributes corresponding to face information obtained by photographing the face of the customer who is guided to the position; and
associating attribute information of the determined attributes with sales object information of the sales object to which the transaction processing is carried out.
